(19) United States
(12) Patent Application Publication
(10) Pub. No.: US 2010/0247038 A1
(43) Pub. Date: Sep. 30, 2010

(54) Coupling Device for Coupling Optical Waveguides

(76) Inventor: Klaus Hartkorn, Munich (DE)

Correspondence Address: CORNING INCORPORATED, INTELLECTUAL PROPERTY DEPARTMENT, SP-TI-3-1, CORNING, NY, 14831, US

(21) Appl. No.: 12/814,008

(22) Filed: Jun. 11, 2010

Related U.S. Application Data
(63) Continuation of application No. PCT/EP08/66816, filed on Dec. 4, 2008.

(30) Foreign Application Priority Data
Dec. 13, 2007 (DE) 202007017386.5

(51) Int. Cl. G02B 6/32; G02B 6/34; G02B 6/42

(52) U.S. Cl. 385/35; 385/36; 385/33; 385/31; 385/50

(57) ABSTRACT

A coupling device for coupling optical waveguides comprises a first side for coupling first optical waveguides to the coupling device, and a second side for coupling second optical waveguides to the coupling device, and an optical system arranged between the first and second sides of the coupling device. The optical system alters a beam path of light coupled out from the first optical waveguides and coupled into the coupling device at the first side in such a way that the light is coupled out from the coupling device at the second side and is coupled into the second optical waveguides, wherein the first optical waveguides are arranged spatially differently with respect to one another than the second optical waveguides.

### PRIORITY APPLICATIONS

This application is a continuation of International Application No. PCT/EP08/066816 filed on Dec. 4, 2008, which claims priority to German Application No. 202007017386.5 filed on Dec. 13, 2007, both applications being incorporated by reference herein.

### TECHNICAL FIELD

The invention relates to a coupling device for coupling optical waveguides, for example a coupling device which couples optical waveguides arranged at an optical chip to optical waveguides of a fiber ribbon.

### BACKGROUND

In the case of a fiber ribbon, a multiplicity of optical waveguides are arranged alongside one another. In one possible embodiment of the fiber ribbon, in which the optical waveguides have a diameter of 125 μm, the distance (pitch) between the individual optical waveguides of the fiber ribbon can be 250 μm, for example. The optical waveguides of the fiber ribbon are generally connected to a device for processing optical signals that are transmitted via the optical waveguides, or to a conversion device for converting optical into electrical signals. Such devices for optical signal processing can be arranged on a chip.

In order to feed light to the signal processing devices, a multiplicity of optical waveguides are fitted on the chip. In order to couple the optical waveguides of the fiber ribbon to the optical waveguides incorporated on the chip, a coupling device is used, wherein the optical waveguides on the chip are arranged in the same spatial arrangement, in particular at the same distance from one another, as the optical waveguides of the fiber ribbon. Therefore, in a manner governed by the distance between the optical waveguides of the fiber ribbon, the optical waveguides on the chip, by way of example, are likewise arranged at a distance of 250 μm on a substrate of the chip. As a result of the large distance between the optical waveguides on the chip, in general valuable chip area is lost.

It is desirable to specify a coupling device which enables optical waveguides which in each case are arranged spatially differently, for example are at different distances from one another, to be coupled to one another. Furthermore, there is a need to specify a system for coupling optical waveguides. It is also desirable to specify a method for coupling optical waveguides.

Claim 1 specifies such a coupling device for coupling optical waveguides, in particular optical waveguides of a fiber ribbon, to optical waveguides arranged on a substrate of a chip. The coupling device enables, in particular, the optical waveguides of the fiber ribbon to be coupled to optical waveguides which are arranged on the substrate of the chip at a smaller distance than the optical waveguides of the fiber ribbon.

One configurational form of the coupling device for coupling optical waveguides comprises a first side for coupling first optical waveguides to the coupling device and a second side for coupling second optical waveguides to the coupling device. The first optical waveguides are arranged at the first side of the coupling device spatially differently with respect to one another than the second optical waveguides are arranged at the second side of the coupling device. The coupling device furthermore comprises an optical system arranged between the first and second sides of the coupling device. The optical system alters a beam path of light coupled out from the first optical waveguide and coupled into the coupling device at the first side in such a way that the light is coupled out from the coupling device at the second side and is coupled into the second optical waveguides. The beam path is altered by means of light refraction at the optical system, wherein the light refraction is dependent on impingement of the radiation on the optical system.

The optical system can contain a lens. The lens can be embodied as a converging lens, for example. The coupling device can furthermore comprise further lenses, which are arranged between the lens and the second optical waveguides. Each of the further lenses is respectively assigned to one of the second optical waveguides in order to couple the light emerging from the lens into the one of the second optical waveguides which is assigned the respective one of the second lenses. The further lenses can be arranged in the coupling device between the lens and one of the first and second sides of the coupling device. The optical system can also contain a spherical lens.

The optical system can have, for example, optical elements each containing optical waveguides. The respective optical waveguides of the optical elements are coupled to the first or second optical waveguides. The optical elements are in each case embodied as a spherical half-shell at a side facing the spherical lens.

The optical system can alter the beam path of the light coupled out from the first optical waveguides arranged in a plane in such a way that the light is emitted at the second side of the coupling device and is coupled into the second optical waveguides arranged in different planes.

The optical system can contain a plurality of plane-parallel plates, for example. The plurality of plane-parallel plates can be respectively assigned to one of the first and second optical waveguides in order to alter the beam path of the light coupled out from the one of the first optical waveguides and coupled into the coupling device at the first side in such a way that the light is emitted from the coupling device at the second side and is coupled into one of the second optical waveguides. The plurality of plane-parallel plates can be arranged in an alternating direction with respect to one another.

The optical system can furthermore contain a plurality of prisms. In each case one of the prisms can be assigned to one of the first optical waveguides at the first side of the coupling device. A further one of the prisms can be assigned to one of the second optical waveguides at the second side of the coupling device. The one of the prisms can be oriented in such a way that the light emerging from the one of the first optical waveguides at the first side of the coupling device is radiated into the one of the prisms and is directed onto the further one of the prisms. The further one of the first prisms can be oriented in such a way that the light directed onto the further one of the prisms is emitted from the second side of the coupling device and is coupled into the one of the second optical waveguides.

The coupling device can comprise, for example, a guide pin, which projects from the coupling device at one of the first and second sides, for fixing the coupling device to a component containing the first and second optical waveguides. The coupling device can furthermore comprise a cavity, which is suitable for receiving a guide pin of a component containing the first and second optical waveguides, in order to fix the coupling device to the component. The further lenses can be fixed to the guide pin.

The first optical waveguides can be arranged at a first component. The second optical waveguides can be arranged at a second component. The first optical waveguides can be arranged at the first component at a different distance from one another than the second optical waveguides are arranged at the second component.

The first optical waveguides can be arranged at a first component and the second optical waveguides can be arranged at a second component. The first optical waveguides are arranged at the first component in a plane. The second optical waveguides are arranged at the second component in different planes.

At least one of the first and second components can be embodied as an optical chip, for example. At least one of the first and second components can also be embodied as a ferrule, for example.

A system for coupling optical waveguides comprises a first component comprising first optical waveguides, and a second component comprising second optical waveguides. The system furthermore comprises a coupling device having a first side, at which the first component is coupled to the coupling device, and having a second side, at which the second component is coupled to the coupling device. The first optical waveguides in the first component are arranged at the first side of the coupling device spatially differently with respect to one another than the second optical waveguides in the second component are arranged at the second side of the coupling device. The coupling device furthermore comprises an optical system. The optical system alters a beam path of light coupled out from the first optical waveguides and coupled into the coupling device at the first side in such a way that the light is coupled out from the coupling device at the second side and is coupled into the second optical waveguides. The beam path is altered by means of light refraction at the optical system, wherein the light refraction is dependent on the impingement of the beam path on the optical system.

The optical system can contain a lens, for example a converging lens. The system can also comprise still further lenses, which are arranged between the lens and the second optical waveguides. Each of the further lenses is respectively assigned to one of the second optical waveguides in order to couple the light emerging from the lens into the one of the second optical waveguides which is assigned the respective one of the second lenses. Furthermore, the optical system can contain a plurality of plane-parallel plates. The plurality of plane-parallel plates can be arranged in an alternating direction with respect to one another.

A method for coupling optical waveguides provides for using a coupling device, wherein first optical waveguides are arranged at a first side of the coupling device spatially differently with respect to one another than second optical waveguides are arranged spatially with respect to one another at a second side of the coupling device. The method furthermore provides for coupling out light from the first optical waveguides. The coupled-out light is coupled into the coupling device. A beam path of the light coupled into the coupling device is altered by means of an optical system in such a way that the light coupled out from the coupling device is coupled into second optical waveguides. In this case, the beam path of the light is altered by light refraction at the optical system, wherein the light refraction is altered in a manner dependent on the impingement of the beam path on the optical system.

In the method, the first optical waveguides can be arranged at the first side of the coupling device at a different distance from one another than the second optical waveguides can be arranged at the second side of the coupling device.

The first optical waveguides can be arranged at the first side of the coupling device in a plane. The second optical waveguides can be arranged at the second side of the coupling device in different planes.

The invention is explained in greater detail below with reference to figures showing exemplary embodiments of the present invention. In the figures:

### BRIEF DESCRIPTION OF THE DRAWINGS

FIG. 1 shows an embodiment of a coupling device for coupling optical waveguides which are in each case at different distances from one another,

FIG. 2 shows a further embodiment of a coupling device for coupling optical waveguides which are in each case at different distances from one another,

FIG. 3 shows a further embodiment of a coupling device for coupling optical waveguides which are in each case at different distances from one another,

FIG. 4 shows a further embodiment of a coupling device for coupling optical waveguides which are in each case at different distances from one another,

FIG. 5 shows an arrangement of optical waveguides of a fiber ribbon and of optical waveguides of a chip which are arranged in different spatial planes with respect to one another,

FIG. 6 shows an embodiment of a coupling device for coupling optical waveguides which are arranged spatially in different planes,

FIG. 7 shows an embodiment of an optical system for coupling optical waveguides which are arranged spatially in different planes,

FIG. 8 shows a further embodiment of an optical system for coupling optical waveguides which are arranged spatially in different planes.

### DETAILED DESCRIPTION

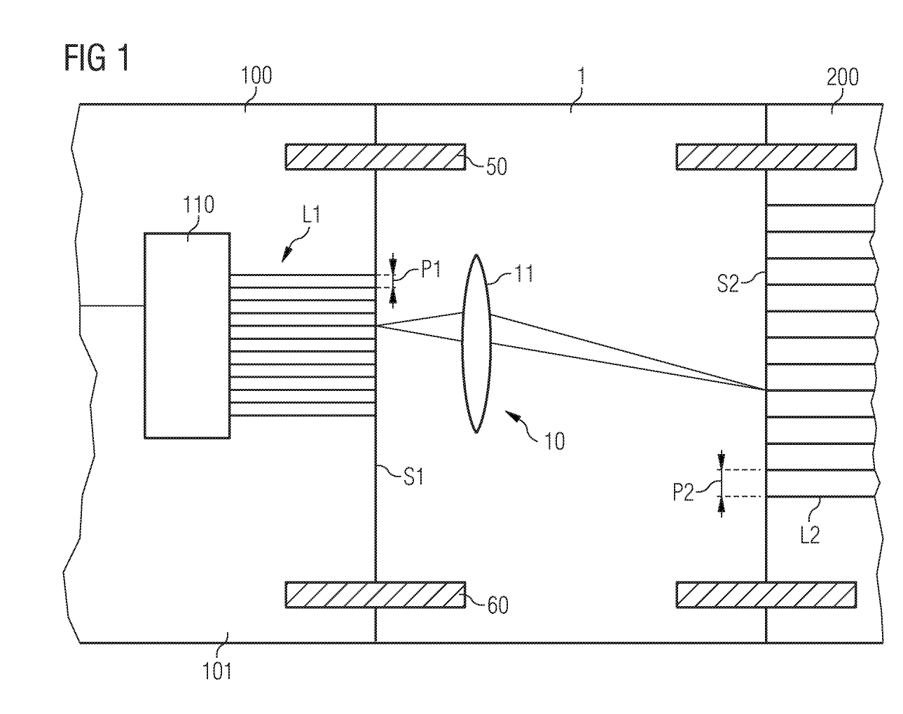

FIG. 1 shows an embodiment of a coupling device 1 for coupling optical waveguides L1 to optical waveguides L2. The optical waveguides L1 are arranged, for example, at a component 100 at a distance (pitch) P1 from one another. The component 100 can be an optical chip, wherein the optical waveguides L1 are incorporated into a substrate 101 of the optical chip. By way of example, devices for the signal processing of the light transmitted via the optical waveguides L1 are arranged on the optical chip 100. By way of example, optical transmitting or receiving devices or else optoelectrical conversion devices for converting optical signals into electrical signals and for converting electrical signals into optical signals can be arranged on the optical chip 100.

Optical waveguides L2 are arranged at a component 200 at a distance (pitch) P2 from one another. The optical waveguides L2 are arranged as a fiber ribbon, for example. The component 200 can be a ferrule, wherein the optical waveguides L2 are inserted into grooves of the ferrule. The ferrule can be an MT ferrule, for example. The distance P2 at which the optical waveguides L2 are spatially arranged with respect to one another in the ferrule 200 is greater than the distance P1 between the optical waveguides L1 fitted to the optical chip 100.

In order to couple the optical waveguides L1 to the optical waveguides L2, a coupling device 1 is arranged between the components 100 and 200. The coupling device 1 has an optical system 10, which enables light coupled out from one of the optical waveguides L1 to be coupled into an optical waveguide L2 associated with the optical waveguide L1.

A beam path of the light that is coupled from one of the optical waveguides L1 into the coupling device 1 is focused onto one of the optical waveguides L2 by means of light refraction at the optical system. In the coupling device, the light can be transmitted between the optical waveguides L1 and the optical system 10 and also between the optical system 10 and the optical waveguides L2 by means of free space propagation, wherein the transmission medium is air, for example. The light refraction is effected in a manner dependent on impingement of the beam path on the optical system.

The light refraction is dependent, for example, on the direction or an angle at which the light impinges on the optical system 10. The optical system can have a curved surface, for example. The curvature of the surface of the optical system 10 is chosen in such a way that the beam path of the light that is radiated from the optical waveguides L1 into the coupling device is altered such that the light emerging from the optical system is coupled into the optical waveguides L2. In addition to the curvature of the surface of the optical system, the thickness of the optical system and the distance of the optical system 10 between the optical waveguides L1 at an input side of the coupling device and the optical waveguides L2 at the output side of the coupling device can also be chosen in such a way that the light coupled out from the optical waveguides L1 is coupled into the optical waveguides L2. In this case, the optical waveguides L1 and the optical waveguides L2 can be arranged spatially differently among one another. The optical waveguides L1 and L2 can be arranged, in particular, at a different distance among one another.

The optical system 10 can contain a lens 11, for example a converging lens. The lens 11 is arranged in the coupling device 1 in such a way that light that is coupled out from one of the optical waveguides L1 and is radiated into the coupling device at a side S1 of the coupling device 1 is emitted from the coupling device by the lens 11 at a side S2 of the coupling device and is coupled into the optical waveguide L2 associated with the optical waveguide L1. In a manner dependent on the magnification factor of the lens 11, optical waveguides which are arranged at different distances on different sides of the lens 11 can be coupled to one another. By way of example, with the arrangement shown in FIG. 1, optical waveguides L1 arranged at a distance of 30 μm from one another on the optical chip 100 at the side S1 of the coupling device can be coupled to optical waveguides L2 arranged at a distance of 250 μm from one another in the form of a fiber ribbon on the side S2 of the coupling device.

For the purpose of mechanically coupling the coupling device 1 to the component 100 and to the component 200, respectively, the coupling device 1 contains guide pins 50, which project from the coupling device at the side S1 and S2, respectively. The guide pins 50 are introduced into cavities 60 of the components 100, 200. If the optical waveguides L1 on the chip 100 and the optical waveguides L2 in the ferrule 200 are oriented with respect to the cavities 60, light coupled out from one of the optical waveguides L1 is coupled into the optical waveguide L2 associated with the optical waveguide L1.

In the embodiment shown in FIG. 1, the coupling-in and coupling-out sides of the coupling device are interchangeable. By way of example, light coupled out from one of the optical waveguides L2, at the side S2, can be radiated into the coupling device 1 and be emitted by the optical system 10 at the side S1 and be coupled into the optical waveguide L1 associated with the optical waveguide L2.

The length and width of the coupling device 1 are dependent on the number of optical waveguides to be coupled, the distance between the optical waveguides, and also the numerical aperture of the optical waveguides. In the case of a system having a distance between the optical waveguides of 50 μm on an input side of the coupling device and a distance between further optical waveguides on an output side of the coupling device of 127 μm, approximately 100 optical waveguides can be coupled to one another by a coupling device having a length of 30 mm if the optical waveguides on the input and output sides in each case have a numerical aperture of 0.15.

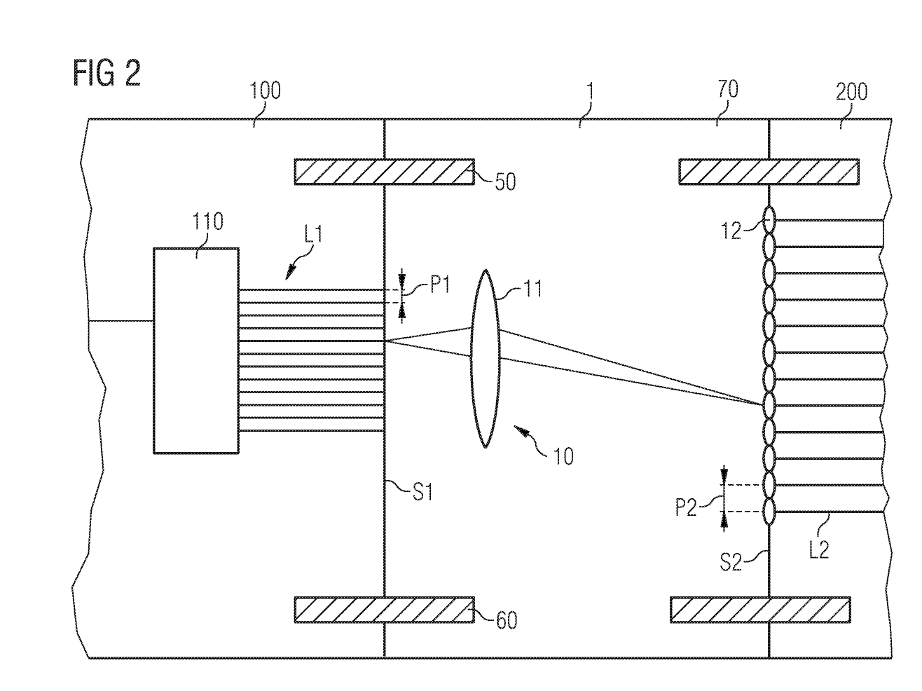

FIG. 2 shows a further embodiment of a coupling device 1, in which the optical system 10 has further lenses 12 besides the lens 11. The lenses 12 are respectively assigned to one of the optical waveguides L2. Losses in the coupling of the optical waveguides L1 to the optical waveguides L2 are largely avoided with the embodiment shown in FIG. 2. The light impinging from the lens 11 on one of the lenses 12 is concentrated anew by the lens 12 and projected onto the optical waveguide L2 associated with the respective lens 12.

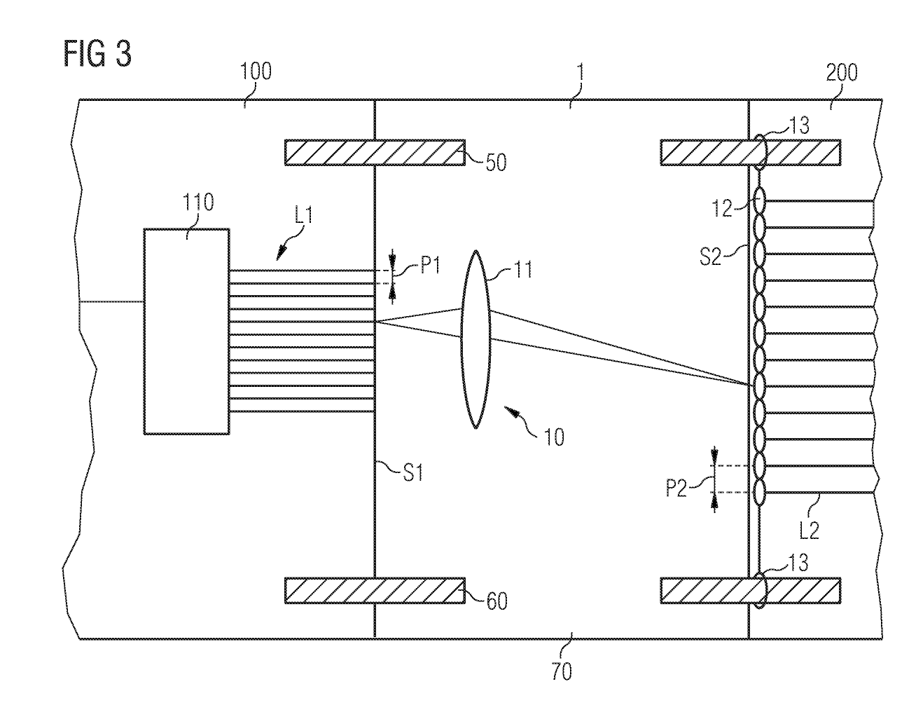

In the embodiment shown in FIG. 2, the further lenses 12 are arranged in integrated fashion in a housing 70 of the coupling device 1. In the embodiment shown in FIG. 3, the further lenses 12 are arranged outside the housing 70. The lenses can be embodied as a component, for example, wherein the lenses are interconnected. The arrangement composed of the lenses 12 can have eyes 13 at the ends thereof. In order to fix the lenses 12 to one of the sides S1 and S2 of the coupling device, the eyes 13 are pushed onto the guide pins 50.

The optical waveguides L1 and L2 generally have different emission/acceptance angles that are dependent on the respective index profile of the optical waveguides L1 and L2. In the embodiments of the coupling device 1 which are shown in FIGS. 2 and 3, power losses that are attributable to the different emission/acceptance angles of the optical waveguides L1 and L2 are avoided by lenses 12 being arranged at at least one of the sides S1 or S2. Lenses 12 disposed upstream of the optical waveguides can be used particularly when the ratios of the emission angles of the optical waveguides L1 and L2 do not correspond to the ratio of the distance differences between the optical waveguides L1 and L2. Furthermore, power losses are avoided by the lenses 12 for example when the lens 11 magnifies in a different ratio than the ratio of the emission angles of the optical waveguides L1 and L2 with respect to one another.

Besides the two embodiments shown in FIGS. 2 and 3, in which the further lenses 12 are embodied as discrete components, there is the possibility of integrating the lenses 12 into the ends of the optical waveguides L1 and L2. The lenses 12 can be integrated into the optical waveguides for example by rounding the fiber ends of the optical waveguides L1 and L2, respectively.

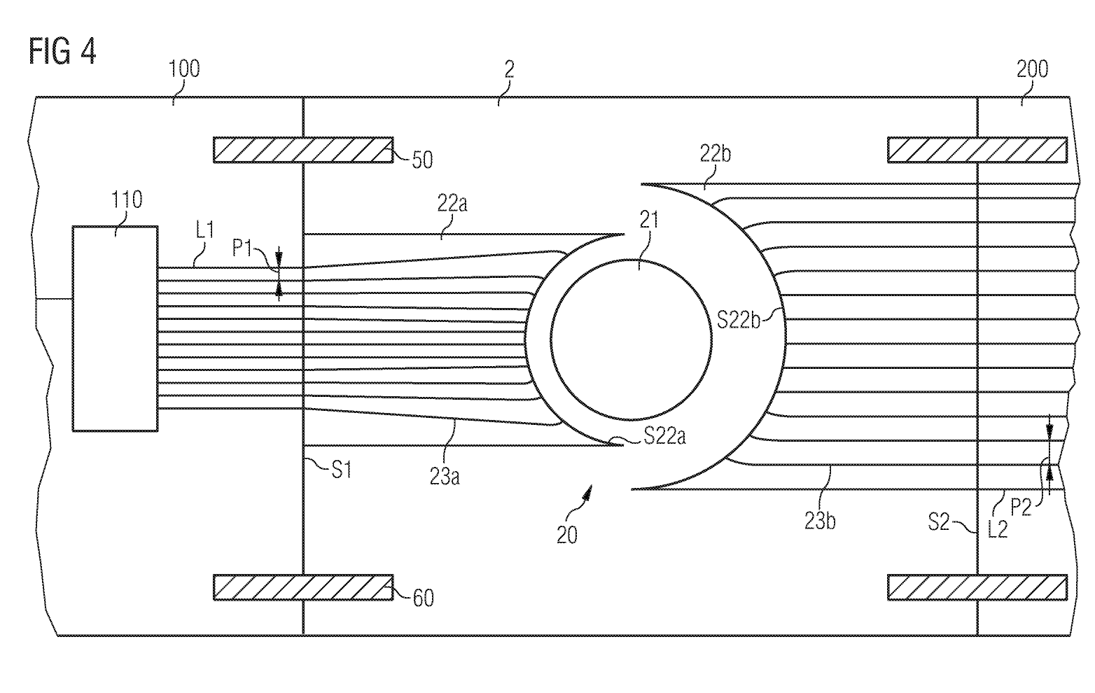

FIG. 4 shows a further embodiment of a coupling device 2. On the component 100, optical waveguides L1 are arranged at a smaller distance from one another than optical waveguides L2 are arranged in the component 200. The component 100 can be an optical chip, for example, wherein the optical waveguides L1 are connected to optical assemblies, for example to transmitting or receiving devices arranged on the chip. The component 200 can be a ferrule, for example an MT ferrule, in which the optical waveguides L2 having a diameter of 125 μm, for example, are arranged at a distance P2 of 250 μm from one another. Between the components 100 and 200, the coupling device 2 is provided for coupling the optical waveguides L1 to the optical waveguides L2. The coupling device 2 is mechanically coupled to the components 100 and 200 by means of guide pins 50 that engage into cavities 60 of the components 100 and 200, respectively.

The coupling device 2 has an optical system 20 comprising a spherical lens 21 and optical elements 22a and 22b. The optical elements 22a and 22b are in each case shaped as hemispherical shells at a side S22a, S22b facing the spherical lens 21. The magnification factor of the lens arrangement of the optical system 20 is formed by the ratio of the different radii of the hemispherical shells 22a and 22b. The optical elements 22a and 22b respectively have optical waveguides 23a and 23b coupled to the optical waveguides L1 and L2. The optical waveguides 23a and 23b are respectively oriented to the mid-point of the spherical lens 21 in the region of the hemispherical sides S22a and S22b of the optical elements 22a and 22b. Since each light beam passes through the mid-point of the lens 21, in this embodiment the diameter of the lens 21 is independent of the number of optical waveguides to be coupled.

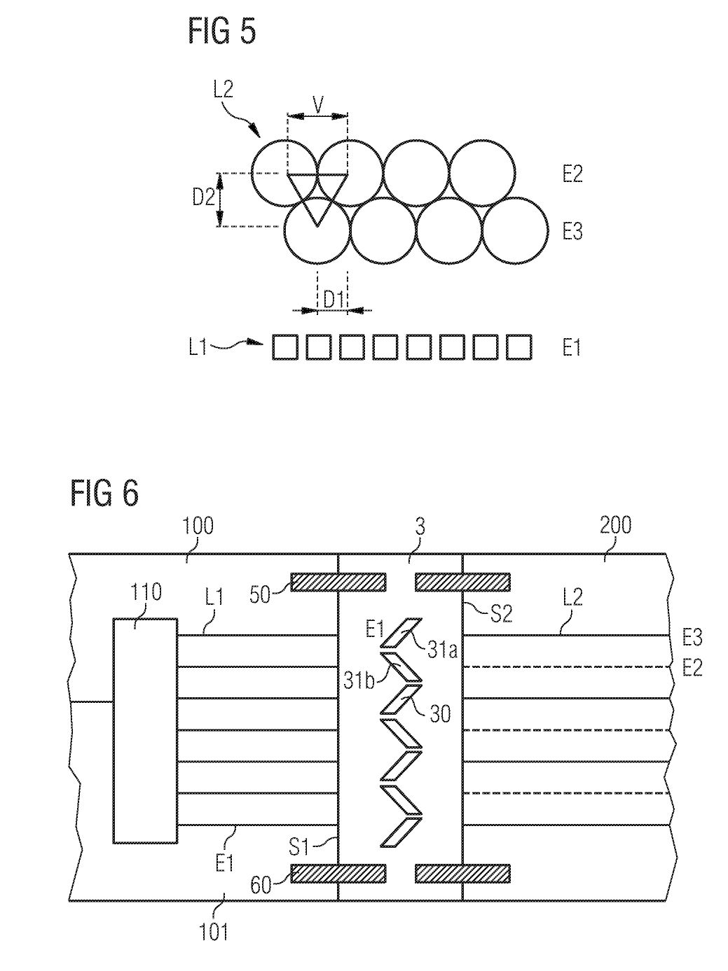

FIG. 5 shows a different spatial arrangement of optical waveguides L1 and L2. The optical waveguides L1 are arranged, for example, on a substrate of an optical chip in a plane E1. The optical waveguides L2 can be, for example, optical waveguides of a fiber ribbon which are arranged in a ferrule for example in two layers in planes E2 and E3. The ferrule can be, for example, an MT ferrule embodied with grooves correspondingly arranged in two layers.

FIG. 6 shows an embodiment of a coupling device 3 which enables light that is coupled out from the optical waveguides L1 to be coupled into the optical waveguides L2 arranged in different planes, as is shown in FIG. 5. The coupling device 3 is arranged between a component 100 and a component 200. The component 100 can be embodied as an optical chip, for example, on which optical waveguides L1 are arranged in a manner lying alongside one another in a plane E1. In the component 200, the optical waveguides L2 are arranged in different planes E2 and E3. The coupling device 3 is fixed to the components 100, 200 by guide pins 50 inserted into cavities 60 of the components 100, 200.

The coupling device 3 contains an optical system 30 containing plane-parallel plates 31a, 31b in a manner corresponding to the number of optical waveguides L1, L2 to be coupled. Each optical waveguide pair L1, L2 is assigned one of the plane-parallel plates. The plane-parallel plates 31a, 31b are arranged in an alternating fashion with regard to their orientation in a row along the sides S1 and S2 of the coupling device 3. The alternating arrangement of the plane-parallel plates enables light that is coupled out from the optical waveguides L1 to be coupled into the optical waveguides L2 arranged in different planes E1 and E3.

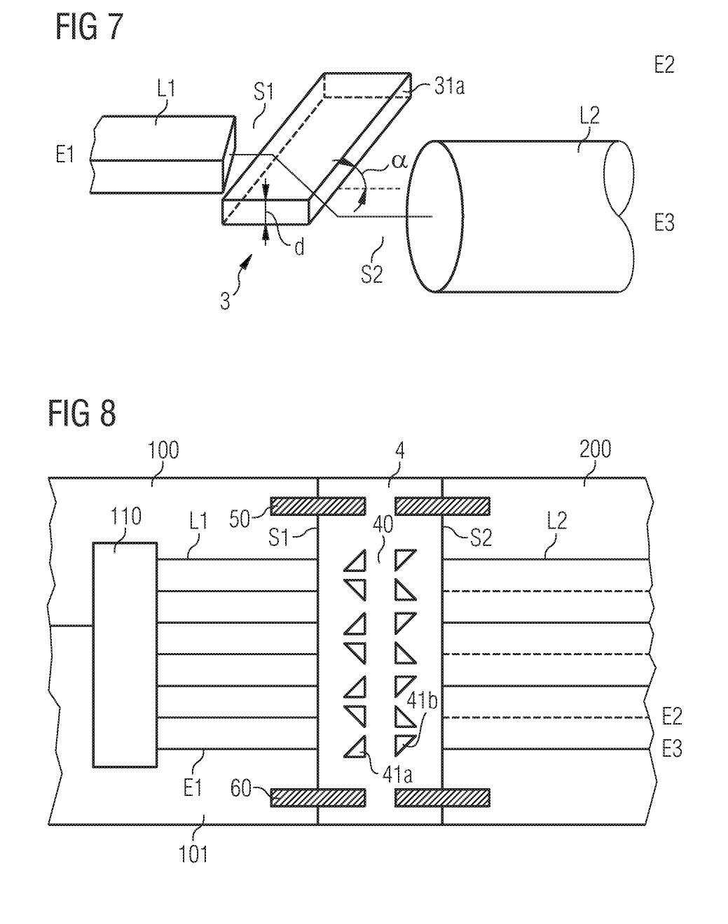

FIG. 7 shows the arrangement of a plane-parallel plate 31a associated with an optical waveguide pair L1, L2. The light beam coupled out from the optical waveguide L1 is radiated into the coupling device at a side S1 of the coupling device 3. The light beam impinges on a side of the plane-parallel plate 31a and is deflected downward within the plane-parallel plate. After emerging from the plane-parallel plate, the light beam is emitted again at the side S2 of the coupling device 3 and is coupled into the optical waveguide L2, which lies in a plane E3 below the plane E1 in which the optical waveguide L1 is arranged.

In order that the light beam coupled out from the optical waveguide L1 is coupled into an optical waveguide L2 arranged in the plane E2 lying above the planes E1 and E3, in accordance with the embodiment shown in FIG. 6, a plane-parallel plate 31b oriented in an opposite direction with respect to the plane-parallel plate 31a shown in FIG. 7 is inserted between the optical waveguides L1 and L2. In order to couple optical waveguides L1 to optical waveguides L2 arranged in different planes, therefore, the plane-parallel plates 31a and 31b, as is shown in FIG. 6, are arranged in an alternating fashion with regard to their orientation.

The arrangement shown in FIG. 6 enables optical waveguides which are arranged on a substrate 101 of a chip 100 with a distance D1=62.5 μm, for example, to be coupled to optical waveguides L2 having a diameter of 125 μm which, as is shown in FIG. 5, are arranged in different planes E2 and E3. In this case, the mid-points of the optical waveguides can have an offset V=125 μm×\sqrt{3}÷4=54 μm. In this exemplary embodiment, the mid-points of the optical waveguides L2 in different planes E2 and E3 can be spaced apart in each case by D2=108 μm. Given a thickness d of the plane-parallel plate, a refractive index n and given a skew angle α of the plane-parallel plate, the offset V results as V=d×sin(α)×(1−(cos(α)÷{square root over ((n×n−sin₂()}α))). Given an offset of V=54 μm, a refractive index of n=3.4 for plane-parallel plates composed of silicon which have a skew angle of 45°, a thickness d of the plane-parallel plate of approximately 97 μm results.

Since no magnification is effected by the optical system 30 in the embodiment of the coupling device 3 as shown in FIG. 6, the orientation or positioning of the plane-parallel plates is possible with a low outlay. A highly precise orientation of the plane-parallel plates is not required. In order to reduce power losses in the transmission of light through the coupling device, it is also possible, for example, in the embodiment shown in FIG. 6, to fit lenses 12, as is shown in FIGS. 2 and 3, in front of the optical waveguides L1 and L2. The lenses 12 can be integrated directly into the coupling device 3 or be fitted to the outer sides S1 and S2 of the coupling device 3. For this purpose, the lenses 12 can be fixed to the guide pins 50, for example.

FIG. 8 shows a further embodiment of a coupling device 4 for coupling out light from optical waveguides L1 and for coupling light into optical waveguides L2 arranged in different planes E2 and E3. Instead of the use of plane-parallel plates 31a, 31b, an optical system 40 containing prisms 41a and 41b is used in the coupling device 4. In the embodiment shown in FIG. 8, a prism 41a is fitted to the side S1 of the coupling device 4 and assigned to one of the optical waveguides L1. A prism 41b oriented oppositely to the prism 41a is arranged at the side S2 of the coupling device 4. In this case, at the side S2 as well, each optical waveguide L2 is assigned one of the prisms 41b.

When prisms are used for beam deflection, the distance between the prisms can be chosen in variable fashion. This enables the planes E2 and E3 to be moved far away from one another, wherein the expansion of the light cone between the prisms 41a and 41b is small.

The use of one of the coupling devices 1, 2, 3 or 4 enables optical waveguides L1 which, by way of example, are arranged on an optical chip 100 spatially differently than optical waveguides L2 which are connected to the chip as a fiber ribbon to be coupled to one another. In particular, it becomes possible to couple optical waveguides which are arranged in a ferrule, for example an MT ferrule, to optical waveguides which are incorporated in a substrate of an optical chip and are at a smaller distance than the optical waveguides of the fiber ribbon.

For the purpose of beam modification in the coupling devices 1, 2, 3 and 4, lens systems 10, 20, 30 and 40 are provided, which can be formed from silicon, which is transparent in the case of the light transmitted through the optical waveguides L1 and L2. The coupling devices 1, 2, 3 and 4 are suitable, for example, for the coupling of optical waveguides in optical backplane designs.

What is claimed is:

1. A coupling device for coupling optical waveguides, comprising:
a first side for coupling first optical waveguides to the coupling device;
a second side for coupling second optical waveguides to the coupling device;
an optical system arranged between the first and second sides of the coupling device,
wherein the optical system alters a beam path of light coupled out from the first optical waveguides and coupled into the coupling device at the first side in a manner dependent on impingement of the beam path on the optical system by means of light refraction in such a way that the light is coupled out from the coupling device at the second side and is coupled into the second optical waveguides, wherein the first optical waveguides are arranged spatially differently with respect to one another than the second optical waveguides.

2. The coupling device of claim 1, wherein the optical system contains a lens.

3. The coupling device of claim 2, further comprising further lenses arranged between the lens and the second optical waveguides, wherein each of the further lenses is respectively assigned to one of the second optical waveguides in order to couple the light emerging from the lens into the one of the second optical waveguides which is assigned the respective one of the second lenses.

4. The coupling device of claim 1, wherein the optical system contains a spherical lens.

5. The coupling device of claim 4, wherein:
the optical system has optical elements each containing optical waveguides,
the respective optical waveguides of the optical elements are coupled to the first or second optical waveguides, and
the optical elements are in each case embodied as a spherical half-shell at a side facing the spherical lens.

6. The coupling device of claim 1, wherein the optical system alters the beam path of the light coupled out from the first optical waveguides arranged in a plane in such a way that the light is emitted at the second side of the coupling device and is coupled into the second optical waveguides arranged in different planes.

7. The coupling device of claim 6, wherein the optical system contains a plurality of plane-parallel plates.

8. The coupling device of claim 7, wherein the plurality of plane-parallel plates are arranged in an alternating direction with respect to one another.

9. The coupling device of claim 6, wherein the optical system contains a plurality of prisms.

10. The coupling device of claim 9, wherein:
in each case one of the prisms is assigned to one of the first optical waveguides at the first side of the coupling device and a further one of the prisms is assigned to one of the second optical waveguides at the second side of the coupling device;
the one of the prisms is oriented in such a way that the light emerging from the one of the first optical waveguides at the first side of the coupling device is radiated into the one of the prisms and is directed onto the further one of the prisms; and
the further one of the prisms is oriented in such a way that the light directed onto the further one of the prisms is emitted from the second side of the coupling device and is coupled into the one of the second optical waveguides.

11. The coupling device of claim 1, further comprising a guide pin, which projects from the coupling device at one of the first and second sides, for fixing the coupling device to a component containing the first and second optical waveguides.

12. The coupling device of claim 1, further comprising a cavity suitable for receiving a guide pin of a component containing the first and second optical waveguides, in order to fix the coupling device to the component.

13. The coupling device of claim 11, wherein the further lenses are fixed to the guide pin.

14. The coupling device of claim 1, wherein the first optical waveguides are arranged at a first component and the second optical waveguides are arranged at a second component, and wherein the first optical waveguides are arranged at the first component at a different distance from one another than the second optical waveguides are arranged at the second component.

15. The coupling device of claim 1, wherein the first optical waveguides are arranged at a first component and the second optical waveguides are arranged at a second component, and wherein the first optical waveguides are arranged at the first component in a plane and the second optical waveguides are arranged at the second component in different planes.

16. The coupling device of claim 14, wherein at least one of the first and second components is embodied as an optical chip.

17. The coupling device of claim 14, wherein at least one of the first and second components is embodied as a ferrule.

18. A system for coupling optical waveguides, comprising:
a first component comprising first optical waveguides;
a second component comprising second optical waveguides; and
a coupling device having a first side, at which the first component is coupled to the coupling device, and having a second side, at which the second component is coupled to the coupling device, wherein
the first optical waveguides are arranged in the first component at the first side of the coupling device spatially differently with respect to one another than the second optical waveguides are arranged in the second component at the second side of the coupling device,
the coupling device comprises an optical system, and
the optical system alters a beam path of light coupled out from the first optical waveguides and coupled into the coupling device at the first side in a manner dependent on impingement of the beam path on the optical system by means of light refraction in such a way that the light is coupled out from the coupling device at the second side and is coupled into the second optical waveguides.

19. The system of claim 18, wherein the optical system contains a lens.

20. The system of claim 19, further comprising further lenses arranged between the lens and the second optical waveguides, wherein each of the further lenses is respectively assigned to one of the second optical waveguides in order to couple the light emerging from the lens into the one of the second optical waveguides which is assigned the respective one of the second lenses.

21. The system of claim 18, wherein the optical system contains a plurality of plane-parallel plates.

22. The system of claim 21, wherein the plurality of plane-parallel plates are arranged in an alternating direction with respect to one another.

23. A method for coupling optical waveguides, comprising:
coupling out light from first optical waveguides;
coupling the light into a coupling device; and
altering a beam path of the light coupled into the coupling device by means of an optical system in a manner dependent on impingement of the beam path on the optical system by means of light refraction in such a way that the light coupled out from the coupling device is coupled into second optical waveguides, wherein the first optical waveguides are arranged at a first side of the coupling device spatially differently with respect to one another than the second optical waveguides are arranged spatially with respect to one another at a second side of the coupling device.

24. The method of claim 23, wherein the first optical waveguides are arranged at the first side of the coupling device at a different distance from one another than the second optical waveguides are arranged at the second side of the coupling device.

25. The method of claim 23, wherein the first optical waveguides are arranged at the first side of the coupling device in a plane and the second optical waveguides are arranged at the second side of the coupling device in different planes.
